(19) United States
(12) Patent Application Publication
(10) Pub. No.: US 2010/0002878 A1
(43) Pub. Date: Jan. 7, 2010

(54) METHOD FOR INPUTTING PASSWORD IN MOBILE TERMINAL

(75) Inventor: Sai-Pang Foong, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/247,429

(22) Filed: Oct. 8, 2008

(30) Foreign Application Priority Data
Jul. 4, 2008 (CN) 200810302525.5

(51) Int. Cl. G09C 3/00

(52) U.S. Cl. 380/54

(57) ABSTRACT

A method for inputting a password in a mobile terminal includes displaying a keypad cryptograph taking a form of a keypad image, in which the symbols arrangement of the input keys in the keypad cryptograph is different from a symbols arrangement of the input keys of a physical keypad of the mobile terminal, and inputting the password through the input keys of the physical keypad being adopted to input symbols indicated by the keypad cryptograph.

### BACKGROUND

1. Field of the Invention

The present invention relates to methods for inputting passwords and, more particularly, to a method for inputting a password in a mobile terminal.

2. Description of Related Art

A typical mobile terminal, such as a mobile phone, is typically provided with a password identification function for protecting against an unauthorized user of the mobile terminal. Once an authorized user has registered a password, no one can make a phone call or use any particular function of the mobile terminal without inputting the correct password. For instance, a call locking function is generally incorporated in most mobile phones for protecting against unauthorized usage. The call locking function provides a method for identifying a password inputted by a user of the mobile phone to prevent use of the mobile phone if an incorrect password is inputted.

The mobile terminal usually includes a keypad for the user inputting the password. Referring to FIG. 3, a typical method for inputting the password in the mobile terminal generally includes the following steps:
S 1: The user inputs a user password to the mobile terminal through a keypad;
S 2: The mobile terminal stores the user password;
S 3: The mobile terminal determines if an entered password is the same as the user password;
S 4: If the passwords match, the user can continue the subsequent operation of the mobile terminal; if the passwords do not match, the mobile terminal will suggest inputting another password until the passwords match.

In this method, the keypad has an uniform key position arrangement and character arrangement on a front panel of the mobile terminal. Therefore, when the password is entered on the keypad by the user, it may be inadvertently observed by a third person, such that the password becomes compromised.

What is needed, therefore, is a method for inputting a password in a mobile terminal, which can efficiently prevent from the password leaking.

### BRIEF DESCRIPTION OF THE DRAWINGS

FIG. 1 is a schematic diagram of a mobile terminal of an embodiment of a method for inputting a password;

FIG. 2 is a flow chart of the method for inputting the password in the mobile terminal; and

FIG. 3 is a flow chart of a typical method for inputting a password in a mobile terminal of related art.

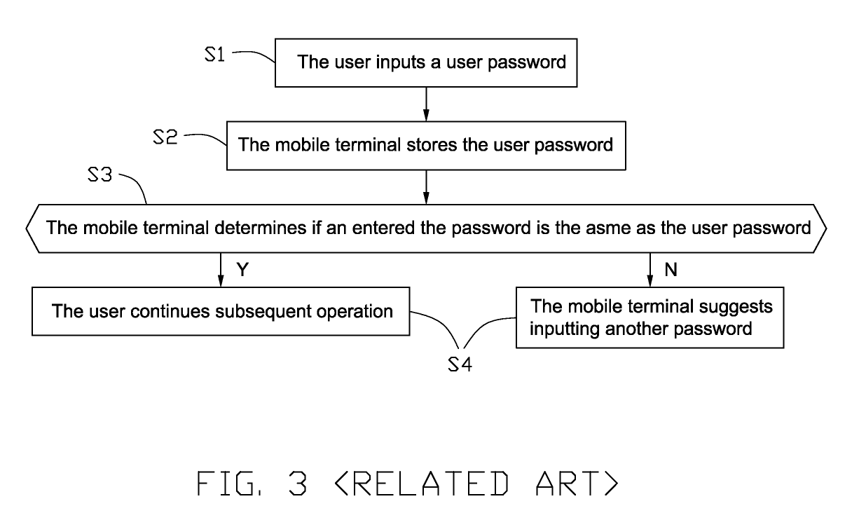

### DETAILED DESCRIPTION

Many aspects of the embodiments can be better understood with reference to the following drawings. The components in the drawings are not necessarily drawn to scale, the emphasis instead being placed upon clearly illustrating the principles of the embodiments.

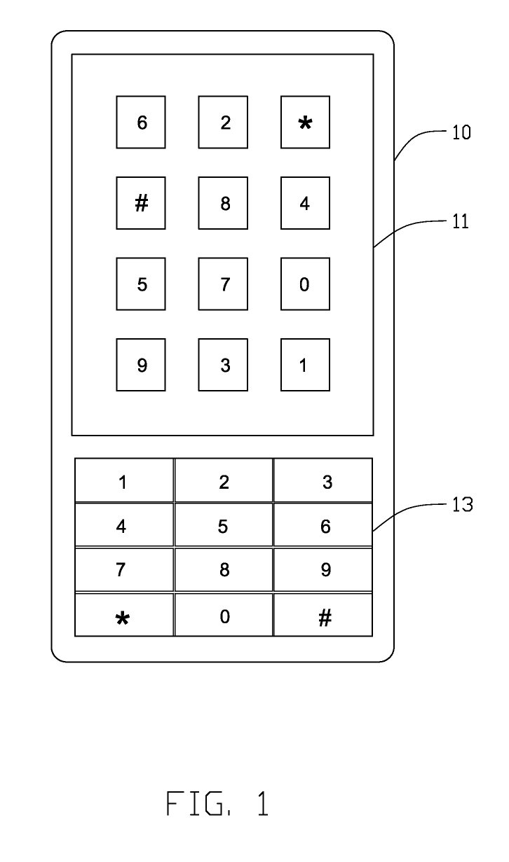

Referring to FIG. 1, a mobile phone 10 includes a screen 11 and a physical keypad 13 positioned on a front panel for inputting information to the mobile phone 10. The mobile phone 10 stores a database (not shown) and a control module (not shown) therein. A keypad cryptograph is stored in the database and displayable on the screen 11. The cryptograph takes a form of a keypad image. The input keys of the keypad image match the input keys of the physical keypad 13. However, the arrangement of the input keys in the keypad image is different from the arrangement of the input keys of the physical keypad 13. A position of each input key of the keypad image maps to the same position as the input key of the physical keypad 13. The control module is configured to control the brightness of the screen 11 of the mobile terminal 10 and control the mobile terminal 10 to display the keypad image on the screen 11. When the mobile terminal 10 prompts for a password input, the control module powers up and decreases the brightness of the screen 11. The screen 11 displays the keypad image. Each input key of the physical keypad 13 adopts the symbol of the input key of the keypad image displayed on the screen 11 based upon the position of each key of the keypad image. For example, in FIG. 1, the number 1 of the physical keypad 13 corresponds to the number 6 of the keypad image, and the character # of the physical keypad 13 corresponds to the number 1 of the keypad image. If the password is 123456, input keys “#20671” should be keyed in using the physical keypad 13 according to the cryptograph. After the correct password has been inputted, the brightness of the screen will return to the previous brightness.

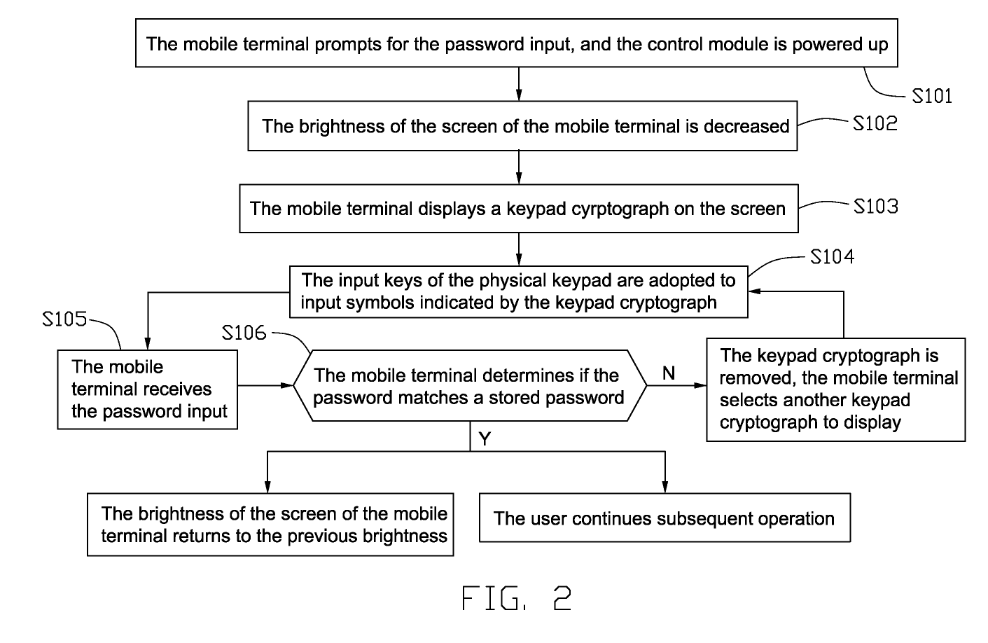

Referring to FIG. 2, is a flow chart of the method for inputting the password in the mobile terminal. Depending on the embodiment, certain of the steps described below may be removed, others may be added, and the sequence of steps may be altered.
S 101: The mobile terminal prompts for the password input via the physical keypad, and the control module is powered up;
S 102: The brightness of the screen of the mobile terminal is decreased;
S 103: The mobile terminal displays a keypad cryptograph on the screen, and the keypad cryptograph takes the form of the keypad image; the symbol of the input keys in the keypad cryptograph is different from the symbol arrangement of the input keys of the physical keypad;
S 104: The input keys of the physical keypad are adopted to input symbols indicated by the keypad cryptograph;
S 105: The mobile terminal receives the password input;
S 106: The mobile terminal determines if the password matches a stored password; if the passwords match, the mobile terminal allows the subsequent operation, and the brightness of the screen will return to the previous brightness; if the passwords do not match, the keypad cryptograph displayed on the screen will be removed, the mobile terminal will randomly select another keypad cryptograph to be displayed on the screen, and return to step 104.

In this embodiment, the symbol arrangement of the input keys in the keypad cryptograph is different from the symbol arrangement of the input keys of the physical keypad, and the password is entered through the physical keypad according to the position of the symbol of the input keys in the keypad cryptograph. Therefore, when the password is entered on the keypad by the user, the third person observing the positions of the fingers is prevented from obtaining the password. Accordingly, the password becomes safe.

It is to be understood, however, that even though numerous characteristics and advantages of the embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for inputting a password in a mobile terminal, comprising:
displaying a keypad cryptograph in the form of a keypad image, wherein an arrangement of symbols of the input keys in the keypad cryptograph is different from an arrangement of symbols of the input keys of a physical keypad of the mobile terminal; and
inputting the password through the input keys of the physical keypad being adopted to input symbols indicated by the keypad cryptograph.

2. The method of claim 1, wherein the keypad cryptograph is displayed on a screen of the mobile terminal.

3. The method of claim 2, further comprising:
decreasing the brightness of the screen via a control module of the mobile terminal when prompting for the password input;
returning the brightness to a previous brightness setting via the control module when inputting the password is finished.

4. The method of claim 1, further comprising:
receiving the password by the mobile terminal;
determining if the password matches a stored password; and
continuing a subsequent operation if the passwords match.

5. The method of claim 4, further comprising in response to determining that the passwords do not match, removing the displayed keypad cryptograph, randomly displaying another keypad cryptograph, and returning to inputting the password.

6. A method for inputting a password in a mobile terminal having a physical keypad, comprising:
prompting inputting the password by the mobile terminal;
decreasing a brightness of a screen of the mobile terminal;
displaying a keypad cryptograph in the form of a keypad image on the screen, wherein an arrangement of symbols of the input keys in the keypad cryptograph is different from an arrangement of symbols of the input keys of the physical keypad;
inputting the password through the input keys of the physical keypad being adopted to input symbols indicated by the keypad cryptograph; and
returning the brightness of the screen to a previous brightness setting.

7. The method of claim 6, wherein a control module stored in the mobile terminal decreases the brightness of the screen, and returns the brightness to the previous brightness setting.

8. The method of claim 6, further comprising:
receiving the password by the mobile terminal;
determining if the password matches a stored password; and
continuing a subsequent operation if the password is correct.

9. The method of claim 8, further comprising in response to determining that the passwords do not match, removing the displayed keypad cryptograph, randomly displaying another keypad cryptograph, and returning to inputting the password.
